(19) United States
(12) Patent Application Publication
(10) Pub. No.: US 2023/0415795 A1
(43) Pub. Date: Dec. 28, 2023

(54) ZIPLINE BRAKING SYSTEM WITH PASSIVE BRAKING TROLLEY

(71) Applicant: Michael Troy Richardson, Santaquin, UT (US)

(72) Inventor: Michael Troy Richardson, Santaquin, UT (US)

(21) Appl. No.: 18/339,791

(22) Filed: Jun. 22, 2023

Related U.S. Application Data
(60) Provisional application No. 63/354,409, filed on Jun. 22, 2022.

(51) Int. Cl. B61H 9/02; B61B 7/00; A63G 21/22

(52) U.S. Cl. CPC B61H 9/02; B61B 7/00; A63G 21/22

(57) ABSTRACT

For braking a zip line trolley, a wheel rides on the zip line cable. An array of toothed slots is disposed downslope from the wheel. A slope adjustment pin is fixed downward into a first toothed slot. At least one selection tab connects the slope adjustment pin to a rider. A brake pad is disposed downslope from the slope adjustment pin. The weight of the rider rotates the brake pad about the wheel to apply a braking force.

### CROSS-REFERENCE TO RELATED APPLICATIONS

This is a conversion of and claims priority to U.S. Provisional Patent Application No. 63/354,409 entitled “ZIPLINE BRAKING SYSTEM with PASSIVE BRAKING TROLLEY” and filed on Jun. 22, 2022 for Michael Troy Richardson, which is incorporated herein by reference.

### BACKGROUND INFORMATION

The subject matter disclosed herein relates to zipline braking.

### BRIEF DESCRIPTION

A brake for zip line trolley is disclosed. The zip line trolley comprises a wheel that rides on the zip line cable. An array of toothed slots is disposed downslope from the wheel. A slope adjustment pin is fixed downward into a first toothed slot. At least one selection tab connects the slope adjustment pin to a rider. A brake pad is disposed downslope from the slope adjustment pin. The weight of the rider rotates the brake pad about the wheel to apply a braking force.

### BRIEF DESCRIPTION OF DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a perspective view drawing illustrating one embodiment is a zipline trolley;

FIG. 2 is front view drawing illustrating one alternate embodiment is a zipline trolley;

FIG. 3 is a side view drawing illustrating one embodiment of a zipline trolley;

FIG. 4 is a perspective drawing illustrating one embodiment of a secondary friction brake;

FIG. 5 is a perspective drawing of one embodiment of a telescoping spring;

FIG. 6 is a perspective drawing of one embodiment of telescoping springs;

FIG. 7 is a perspective drawing of one embodiment of a spring;

FIG. 8 is a perspective drawing of one embodiment of telescoping springs;

FIG. 9A is a side view drawing of one embodiment of a dual tapered telescoping taper spring;

FIG. 9B is a side view drawing of one embodiment of a dual tapered telescoping spring;

FIG. 10 is a perspective view drawing of one embodiment of a mirrored multi-compression coil non-telescoping taper spring;

FIG. 11 is a side view drawing of one embodiment coil of a non-telescoping spring;

FIG. 12 is a front view drawing of one embodiment of a coil non-telescoping spring;

FIG. 13 is a perspective drawing view one embodiment of multi-compression cylinder-shaped coil springs and spring spacer discs;

FIG. 14 is a side drawing view one embodiment of multi-compression cylinder-shaped coil springs and spring spacer discs;

FIG. 15 is a front drawing view of embodiments of multi-compression cylinder-shaped coil springs and spring spacer discs;

FIG. 16 is a front drawing view of one embodiment of a spring spacer disc with multi-compression cylinder-shaped coil spring hook;

FIG. 17 is a perspective drawing view of one alternate embodiment of a multi-compression cylinder-shaped coil spring and a spring spacer disc;

FIG. 18 is a perspective drawing illustrating one embodiment of a trampoline;

FIGS. 19A-E is perspective and side view drawings of one embodiment of perimeter pads; and

FIG. 20 is a perspective drawing of one embodiment of a trampoline with exposed springs.

### DETAILED DESCRIPTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise. The term “and/or” indicates embodiments of one or more of the listed elements, with “A and/or B” indicating embodiments of element A alone, element B alone, or elements A and B taken together.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

The description of elements in each figure may refer to elements of proceeding figures. Like numbers refer to like elements in all figures, including alternate embodiments of like elements.

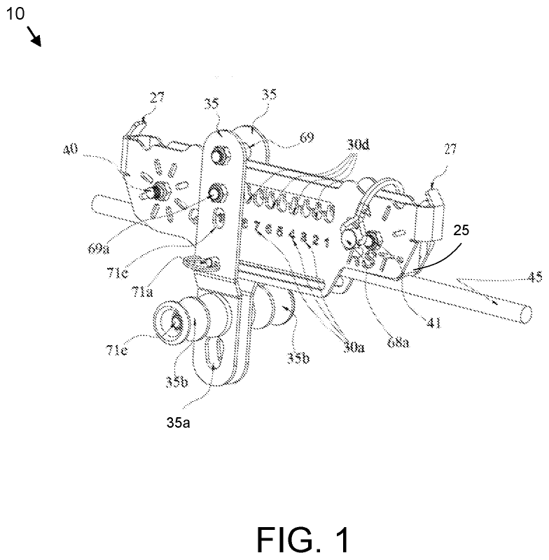

FIG. 1 is a perspective view drawing illustrating one embodiment is a zipline trolley 10 with a slope adjustment pin 69a for varying cable slopes. A wheel (not shown) rides on a zip line cable 45. An array of toothed slots 30d is disposed downslope from the wheel. The slope adjustment pin 69a pin is above the zip line cable 45. The slope adjustment pin 69a seats or is fixed downward into a first toothed slot 30d of the array of toothed slots 30d. The mass of a zipliner or rider is attached to the side selection tabs 35 through egg-shaped slots 35a of the two side selection tabs 35.

The oblong hole 71e exposes the toothed slots 30d of the side selection tab 35 so the zipline guide and participants may identify the proper pin setting in the toothed slots 30d, determining a brake force applied by a brake pad 25 of the zipline trolley 10 on the zip line cable 45. The brake pad 25 may be disposed downslope from the slope adjustment pin 69a. The weight of the rider rotates the brake pad 25 about the wheel to apply a braking force. Numbers 30a at each of the toothed slots 30d indicate the differing amounts of brake force applied differing slopes of the zipline cable 45. Toothed slots 30d in the range of 2-20 may be provided. Will In the depicted embodiment, 11 toothed slots 30d are provided.

A secondary redundant safety axle 69 provides added safety. A brake pad axle 41 is centered to allow three-hundred-sixty-degree rotation of a brake pad 25. A wire clasp 68a pin provides backup safety. The locating safety lock pin 71a prevents the trolley from bouncing of the zipline cable. A carriage bolt 71f secures participant anti-twist handles 35b. The bent tabs 27 at the distal and proximal ends retain life safety carabiners loosely connected to the participant. A shouldered axle shaft 40 holds the wheel.

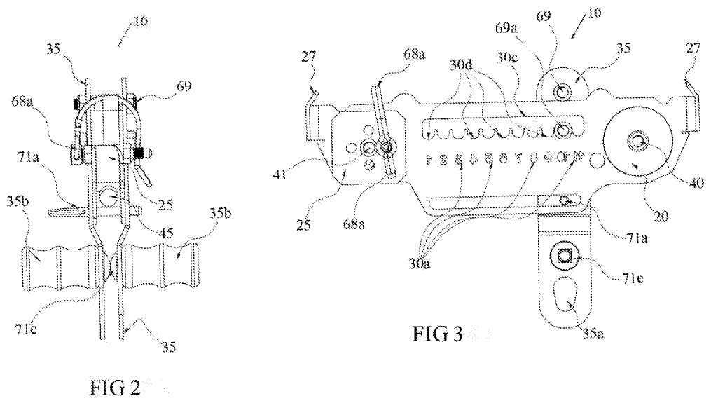

FIG. 2 is front view drawing illustrating one alternate embodiment is a zipline trolley 10. The brake pad 25 rest atop the cable 45. The brake pad 25 is disposed downslope from the slope adjustment pin 69a. A weight of a rider rotates the brake pad 25 about the wheel 25 to apply a braking force proportional to the position of the slope adjustment pin 69a in the toothed slots 30d.

Removing the locating safety lock pin 71a allows removal of the zipline trolley suspended atop cables 45. Safety anti-twist handles 35b are safety devices meant to reduce and limit participant rotation. Removing the locating safety lock pin 71a allows the two side tabs 35 to be separated when removing the trolley from the cable. removal of the zipline trolley suspended atop cables 45. A secondary redundant safety axle 69 is an added for safety. A carriage bolt 71e fastened the handle 35b to the side tab 35.

FIG. 3 is a side view drawing illustrating one embodiment of a zipline trolley with a side plate removed exposing the brake 25. The wheel 20 rides on the zip line cable 45. In one embodiment, a single wheel 20 rides on the zip line cable 45. Alternatively, two or more wheels 25 may be employed. A range of numbers 30a correspond to lever positions of the slope adjustment pin 69a for the zip line trolley 10. The toothed slots 30d are disposed downslope from the wheel 20. Each number 30a lever of a toothed slot 30d corresponds to a specific braking force selected for a zipliners specific body weight. Each zipline owner will determine the numbers and corresponding braking force needed for their course.

The toothed slot 30c allow a specified brake force to be applied based on the position of the rider suspended from the lever arm in the oblong hole 35a. The brake pad axle 68a is sandwiched between the two large side plates with eleven positions for slopes in the range of five to sixty percent. The egg-shaped hole 35a is the weight bearing connection point for all writers. Removing the wire-clasp pin 68a allows for brake rotation at 90, 180, 270, and 360 degrees. At the proximal and distal ends of the trolley side plate are two bent tabs 27 prevent safety carabiners (not shown) bouncing off during the ride. The trolley wheel 20 is centered on a shouldered axle shaft 40.

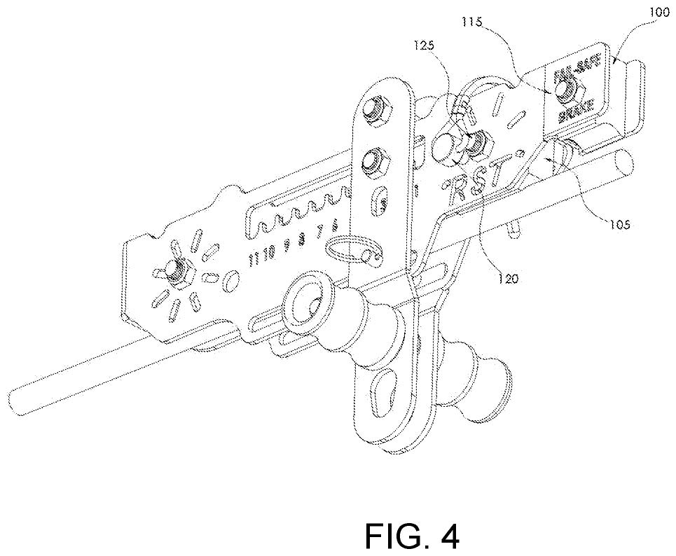

FIG. 4 is a perspective drawing illustrating a secondary friction brake 100. The secondary friction brake 100 is made from a polymer and acts as a fail-safe brake system that backs up the primary brake 105 in the event the primary brake 105, 120 pin, and 125 axle failed due to wear and corrosion.

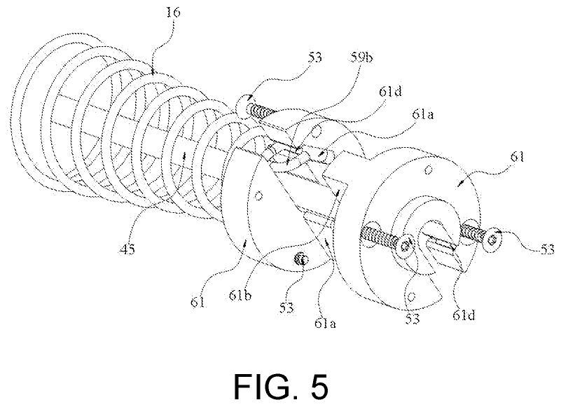

FIG. 5 is a perspective drawing of a dual taper, telescoping dual taper, mirrored frustum, or telescoping spring 16 with one embodiment of a protruding spring hook 59b positioned to rotate into slot 61a. A spring 16 may be used to stop the zip line trolley 10. When the spring hook 59b is rotated into the u-groove 61d the end condition of the spring hook 59a nested into concave diagonal locking slot 61a providing clearance for two inner Ultra High Molecular Weight Polyethene, aluminum bronze, or lightweight aircraft aluminum discs 61 that are mirrored and rotated 180 degrees allowing 61a and 61b sandwich together locking the spring 16 hook in slot 61d and 61a. The protruding tabs 61a and 61b holds one or two dual taper telescoping springs. wires coils prevent the rotation of the spring and locking the inner distal 59a and proximal 59b hooked ends of the dual taper apex descending telescoping springs ends 59a and 59b. Two mirrored discs 61 spacer 61 may be formed of Ultra High Molecular Weight Polyethylene.

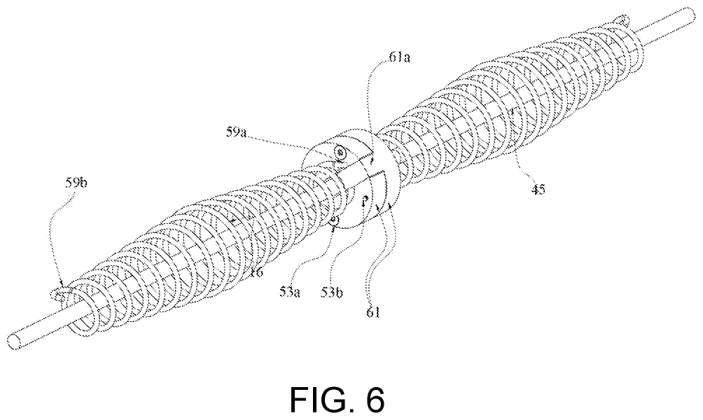

FIG. 6 is a perspective drawing of a tapered telescoping cable centering spring array, dual taper telescoping springs 16 with one embodiment of the discs 61 sandwich together locking together the two dual taper telescoping springs 16 hook in slot 61d and 61a. The protruding tabs 61a and 61b holds one or two dual taper telescoping springs 16 wire loops preventing the rotation of the spring and locking the inner ends of the dual taper telescoping springs 16 to the spring spacer 61 may be formed of Ultra High Molecular Weight Polyethylene. The two embodiments of the spring spacers 61 mate together and fastened by three or more opposing plastic forming metal screws 53a and 53b.

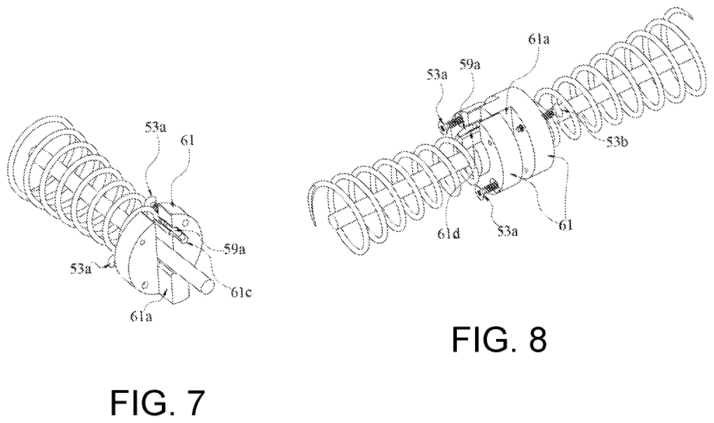

FIG. 7 is a perspective drawing of a spring 16 with one spring embodiment and one disc 61 with grooved cut slot 61c for the spring 16 hook to nests in the disc 61 slot 61c allowing clearance for sandwiching two 61 discs extruded protruding tabs 61a. and 61b holds one or two dual tapered telescoping dual taper telescoping springs 16 wire loops preventing the rotation of the spring and locking the inner ends of the dual taper telescoping springs 16 to the spring spacer 61 may be formed of Ultra High Molecular Weight Polyethylene. The two embodiments of the spring spacers 61 lock together and fastened by 53a and 53b opposing plastic forming metal screws.

FIG. 8 is a perspective drawing of a section view of one embodiment of two dual tapered telescoping dual taper telescoping springs 16 and two embodiment and one disc spring spacer 61 with grooved cut slot 61c for the spring 16 hook to nests in the disc spring spacer 61 concaved slot 61c allowing clearance for sandwiching two 61 discs extruded protruding tabs 61a and 61b holds one or two dual taper telescoping springs 16 wire loops preventing the rotation of the dual taper telescoping springs and locking the inner ends of the dual taper telescoping springs 16 to the disc spring spacer 61 and fastened by several 53a and 53b opposing plastic forming metal screws.

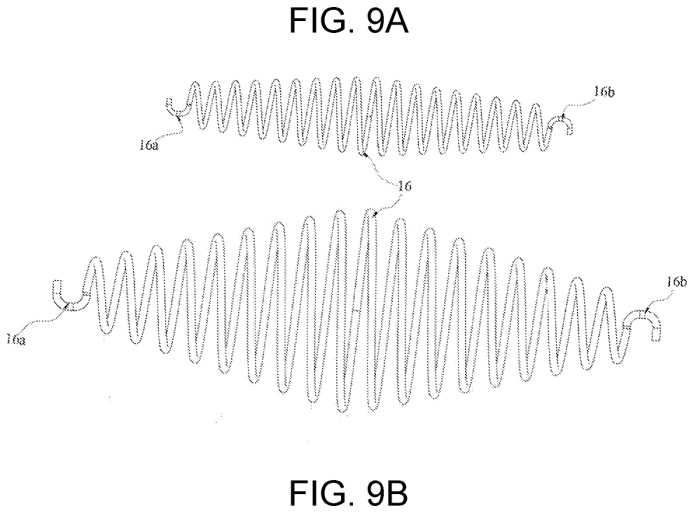

FIG. 9A is a side view drawing of one embodiment of a dual tapered telescoping taper spring 16. The hooked opposing end conditions 16a and 16b.

FIG. 9B is a side view drawing of one embodiment of a dual tapered telescoping spring 16. The hooked opposing end conditions 16a and 16b. A tapered football-shaped spring compresses between 16c and 16d in the range of 10.0-7.5 inch-pounds, 16b and 16e in the range of 8.5-5.5 inch-pounds, 16e and 16f in the range of 15-5 inch-pounds, 16f and 16g in the range of 9.5-7.5 inch-pounds, 16g and 16h in the range of 7.5-6.5 inch-pounds 16h and 16i in the range of 6.5-5.5 inch-pounds, 16i and 16j in the range of 0.5-0.25 inch-pounds, 16j and 16k in the range of 20-2 inch-pounds, 16k and 16m in the range of 20-2 inch-pounds, 16m and 16n in the range of 20-2 inch-pounds

FIG. 10 is a perspective view drawing of one embodiment of a mirrored multi-compression coil non-telescoping taper spring 17. The hooked opposing end conditions 16a and 16b.

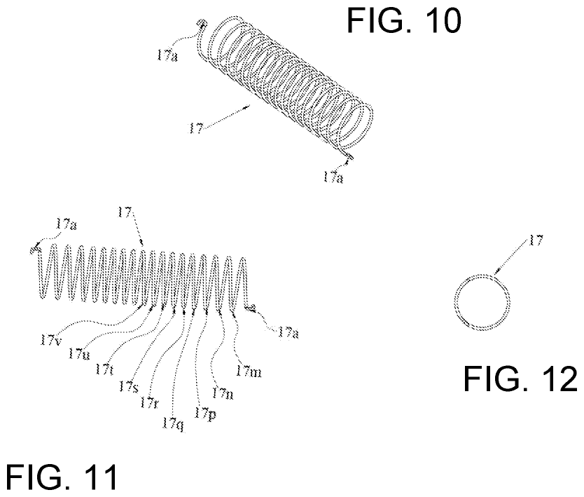

FIG. 11 is a side view drawing of one embodiment of a coil non-telescoping spring 17. The hooked opposing end conditions 17a and 17b. A cylindrical coil spring compresses between 17a and 17m in the range of 10.0-7.5 inch-pounds, 17m and 17n in the range of 8.5-5.5 inch-pounds, 17n and 17p in the range of 10-5 inch-pounds, 17p and 17r in the range of 9.5-7.5 inch-pounds, 17r and 17s in the range of 7.5-6.5 inch-pounds 17s and 17t in the range of 6.5-5.5 inch-pounds, 17t and 17u in the range of 0.5-0.25 inch-pounds, 17u and 17v in the range of 10-5 inch-pounds, 17v to the center in the range of 10-5 inch-pounds

FIG. 12 is a front view drawing of one embodiment of a coil non-telescoping spring 17.

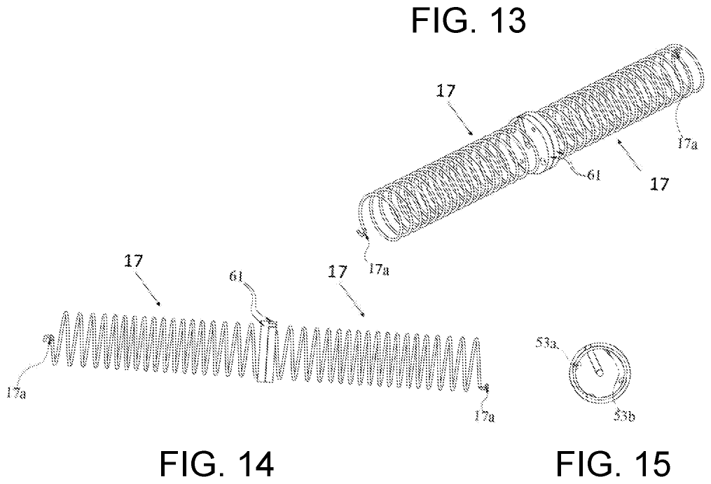

FIG. 13 is a perspective drawing view of multi-compression cylinder-shaped coil springs 17 and spring spacer discs 61 embodiments sandwiched together with spring hooks 17a at both ends of the assembly.

FIG. 14 is a side drawing view of the embodiments of multi-compression cylinder-shaped coil springs 17 and spring spacer discs 61 of FIG. 13 sandwiched together with spring hooks 17a at both ends of the assembly.

FIG. 15 is a front drawing view of embodiments of multi-compression cylinder-shaped coil springs 17 and spring spacer discs 61 of FIGS. 13 and 14 sandwiched together with spring spacer discs fastened with several opposing thread-forming screws 53a and 53b.

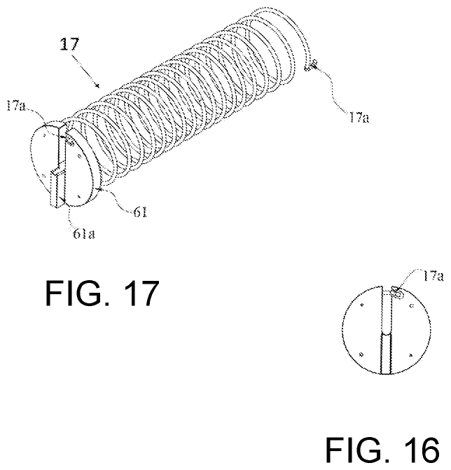

FIG. 16 is a front drawing view of one embodiment of a spring spacer disc 61 with multi-compression cylinder-shaped coil spring hook 17a nested in the grooved cut slot.

FIG. 17 is a perspective drawing view of one embodiment of a multi-compression cylinder-shaped coil spring 17 and a spring spacer disc 61 with the spring hook 17a nested in the grooved cut slot.

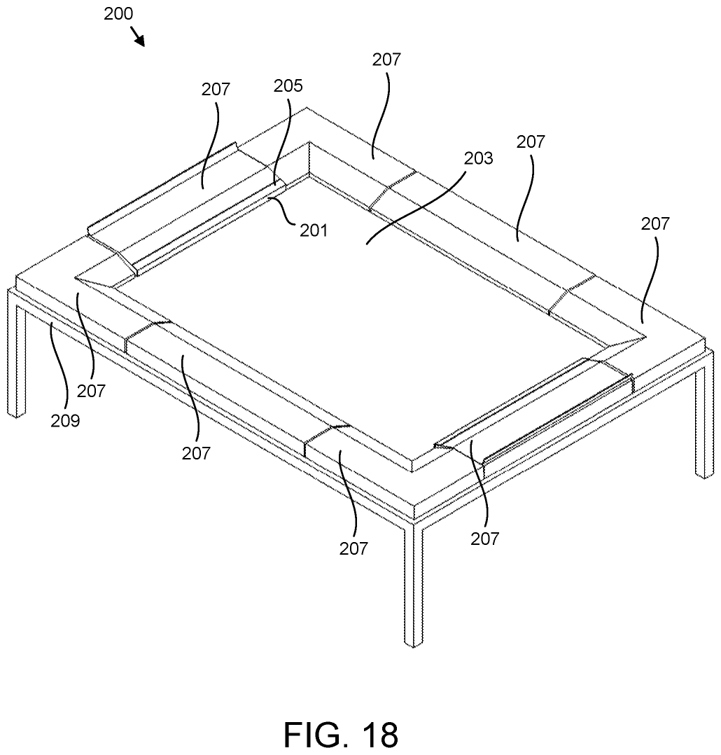

FIG. 18 is a perspective drawing illustrating one embodiment of a trampoline 200. A trampoline bed 203 is suspended from a frame 209 by springs (not shown). Perimeter pads 207 are disposed to cover the springs. The perimeter pads 207 include a hook-and-loop faster (HFL) 201 disposed on a pad nose 205. The HFL 201 secures the perimeter pad 207 to the trampoline bed 203. Because the HFL 201 is on the pad nose 205, the connection between the HFL 201 and trampoline bed 203 may be verified visually from a distance, increasing safety.

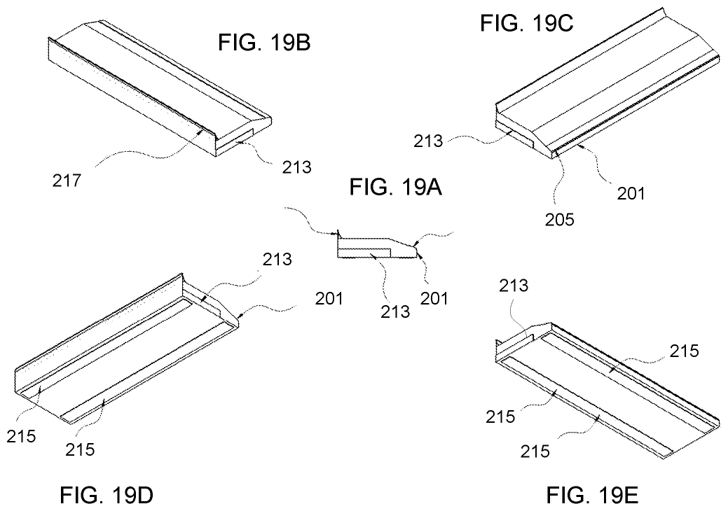

FIGS. 19A-E is perspective and side view drawings of one embodiment of perimeter pads 207. Side HFL 213, bottom HFL 215, and top HFL 217 are shown.

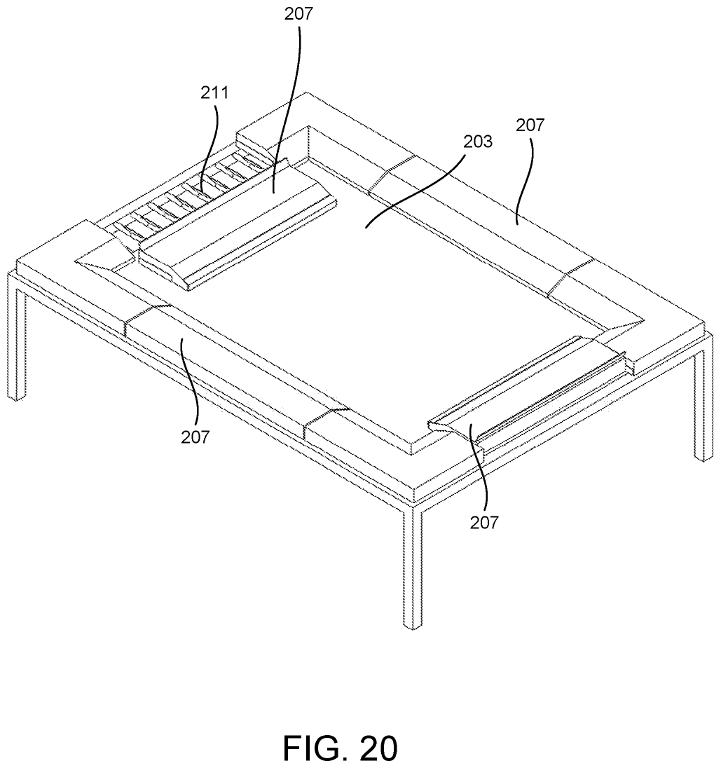

FIG. 20 is a perspective drawing of one embodiment of a trampoline 200 with exposed springs 211.

This description uses examples to disclose the invention and also to enable any person skilled in the art to practice the invention, including making and using any devices or systems and performing any incorporated methods. The patentable scope of the invention is defined by the claims and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A zipline trolley comprising:
a wheel that rides on a zip line cable;
an array of toothed slots disposed downslope from the wheel;
a slope adjustment pin that is fixed downward into a first toothed slot,
at least one selection tab that connects the slope adjustment pin to a rider,
a brake pad disposed downslope from the slope adjustment pin, wherein a weight of the rider rotates the brake pad about the wheel to apply a braking force.

2. The zipline trolley of claim 1, wherein the brake pad rotates 360 degrees about a brake pad axle.

3. The zipline trolley of claim 1, wherein a hole exposes the first toothed slot.

4. The zipline trolley of claim 3, wherein the hole further exposes a number corresponding to the first toothed slot.

5. The zipline trolley of claim 1, further comprising a secondary friction brake.

6. The zipline trolley of claim 1, wherein the zipline trolley is stopped by a spring.

7. The zipline trolley of claim 6, wherein the spring is a telescoping tool taper spring.

8. The zip line trolley of claim 6, wherein the spring is a mirrored multi-compression coil non-telescoping taper spring.

9. The zip line trolley of claim 6, wherein a disc locks two springs.

10. The zip line trolley of claim 9, the disk comprising a grooved cut slot.
